(19) United States
(12) Patent Application Publication
(10) Pub. No.: US 2001/0051030 A1
(43) Pub. Date: Dec. 13, 2001

(54) Optical fiber configuration

(76) Inventor: Roland Höfner, K?uuml;ps (DE)

Correspondence Address: LERNER AND GREENBEG, P.A., PATENT ATTORNEYS AND ATTORNEYS AT LAW, Post Office Box 2480, Hollywood, FL, 33022-2480, US

(21) Appl. No.: 09/910,343

(22) Filed: Jul. 20, 2001

Related U.S. Application Data
(63) Continuation of application No. PCT/DE00/00574, filed on Feb. 29, 2000.

(30) Foreign Application Priority Data
Mar. 2, 1999 (DE) 199 09 159.5

(51) Int. Cl. G02B 6/44

(52) U.S. Cl. 385/109; 385/107; 385/100

(57) ABSTRACT

In an optical fiber configuration having an optical fiber within a flexible insulating sleeve, which has, at least on one section, peripheral shields made of an insulating material, it is envisaged to apply the shields directly to a sheath made of a glass fiber reinforced plastic. The sheath in turn receives the optical fiber. Such a configuration involves low costs and protects the optical fiber from mechanical influences.

### CROSS-REFERENCE TO RELATED APPLICATION

This application is a continuation of copending International application No. PCT/DE00/00574, filed Feb. 29, 2000, which designated the United States.

### BACKGROUND OF THE INVENTION

Field of the Invention

The invention relates to an optical fiber configuration with an optical fiber for the transmission of information over an electrical potential difference, the optical fiber being disposed within a flexible insulating sleeve, which has, at least on one section, peripheral shields made of an insulating material.

An optical fiber configuration of this type is proposed for example in Published, Non-Prosecuted German Patent Application DE 197 32 489 A1 and, in comparison with the laying of an optical fiber inside a rigid insulating support, also makes possible subsequent installation at a wide variety of points of a high-voltage system. The laying of an optical fiber configuration in a rigid insulating support is known, for example, from Published, European Patent Applications EP 0 146 845 A2 or EP 0 265 737 A1.

The flexibility of the optical fiber configuration compensates for elongations, movements, vibrations and similar mechanical loads. Moreover, the routing of the optical fiber configuration past obstacles is also possible in a simple way.

To protect the optical fiber from tensile forces, which are induced for example by forces of weight on the optical fiber configuration, it is further known from Published, Non-Prosecuted Prosecuted German Patent Application DE 197 32 489 A1 to provide parallel to the optical fibers tension-resistant stabilizing elements, for example in the form of glass reinforced plastic (GRP) rods which are surrounded by the sleeve. GRP here is a plastic reinforced with glass fibers.

The insertion of the stabilizing elements into the optical fiber configuration disadvantageously entails considerable expenditure. A complex holding device for fixing the optical fiber configuration is required both for inserting the stabilizing elements into a customarily provided sheath, which receives the optical fiber, and for inserting the stabilizing elements into the shielding material.

Furthermore, individual stabilizing elements inevitably cannot be disposed in such a way that there is no longer any tensile loading acting on the optical fiber.

### SUMMARY OF THE INVENTION

It is accordingly an object of the invention to provide an optical fiber configuration which overcomes the above-mentioned disadvantages of the prior art devices of this general type, in which, the optical fiber is protected even better from mechanical loads. It is, moreover, intended that such an optical fiber configuration can be produced at low cost and in a simple manner.

With the foregoing and other objects in view there is provided, in accordance with the invention, an optical fiber configuration. The optical fiber configuration has a sheath made of a glass fiber reinforced plastic and a flexible insulating sleeve having peripheral shields disposed along at least on one section of the flexible insulating sleeve. The peripheral shields are made of an insulating material and are applied directly to the sheath. An optical fiber for transmitting information over an electrical potential difference is provided. The optical fiber is disposed in the flexible insulating sleeve.

The object is achieved according to the invention by the shields being applied directly to the sheath made of the glass fiber reinforced plastic, which sheath receives the optical fiber.

By sheathing the optical fiber with the sheath made of theass fiber reinforced plastic, it is effectively protected from mechanical loads. Under tensile or flexural loads, the optical fiber is to a certain extent located in the neutral fiber. The sheathing of the optical fibers with a glass fiber reinforced plastic is known per se and is used for example in the case of underground cables for protection from rodents. In the production of the optical fiber configuration, a complex holding device for the subsequent insertion of stabilizing rods is no longer necessary.

The fact that the shields are applied directly to the sheath dispenses with the need for the otherwise customary sheathing of an optical fiber cable with a plastic. The shields are consequently adhesively bonded, shrink-fitted or injection-molded directly onto the glass fiber reinforced plastic. If the material customary for the shields, silicone rubber, is used, a material combination of glass fiber reinforced plastic and silicone rubber known from composite insulators is present at the boundary layer. Inexpensive coupling agents are commercially available for this.

The production of the optical fiber configuration is consequently made considerably simpler in comparison with the prior art and, moreover, has low costs.

An advantageous refinement of the invention provides for the optical fiber to be additionally sheathed with a buffer tube. A customary commercially available optical fiber cable to a certain extent represents such a sheathed optical fiber. The sheathing made of the glass fiber reinforced plastic can be applied to the optical fiber cable in a way known per se. In this case, the optical fiber cable may, for example, be sheathed with the glass fiber reinforced plastic by simultaneous or alternating application of the glass fibers and the still soft plastic and subsequent curing. A plastic suitable for this purpose is, for example, an epoxy resin.

It is also advantageous to group together a plurality of the optical fibers in the buffer tube. In this way, more information can be transmitted at the same time.

If the shields are formed of a non-flexible material, they must be connected to one another in a flexible way in order to ensure flexibility. The shields can then be pushed individually onto the GRP sheath.

It is also advantageous for the sheath to receive a plurality of buffer tubes. This also allows the exchange of information over the potential difference to be increased. Moreover, optical fiber cables of this type, in which a plurality of buffer tubes with optical fibers integrated in them are grouped together, are customary cables available on the market.

In a further advantageous refinement of the invention, a connection fitting pressed directly onto the sheath is provided. The connection fitting serves in this case for fastening the optical fiber configuration to the high-voltage system. For pressing on, the fitting with an oversized diameter is pushed onto the GRP sheath and fixed. Subsequently, pressing of the fitting onto the GRP sheath takes place by introducing a force distributed uniformly around the circumference. This is a customary method and is known, for example, for applying the fittings to the GRP tube of a composite insulator. Customary materials for the fitting part are, for example, aluminum, malleable cast iron and forgable steels. The fact that the connection fitting is pressed directly onto the GRP sheath results that no problems occur with respect to the sealing of the optical fiber or buffer tube.

Other features which are considered as characteristic for the invention are set forth in the appended claims.

Although the invention is illustrated and described herein as embodied in an optical fiber configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of an optical fiber configuration according to the invention;

FIG. 2 is a side-elevational, partially broken-open, view of a detail of a shielded section of the optical fiber configuration; and

FIGS. 3 and 4 are cross-sectional views of various optical fiber configurations.

### DESCRIPTION OF THE PREFERRED EMBODIMENTS

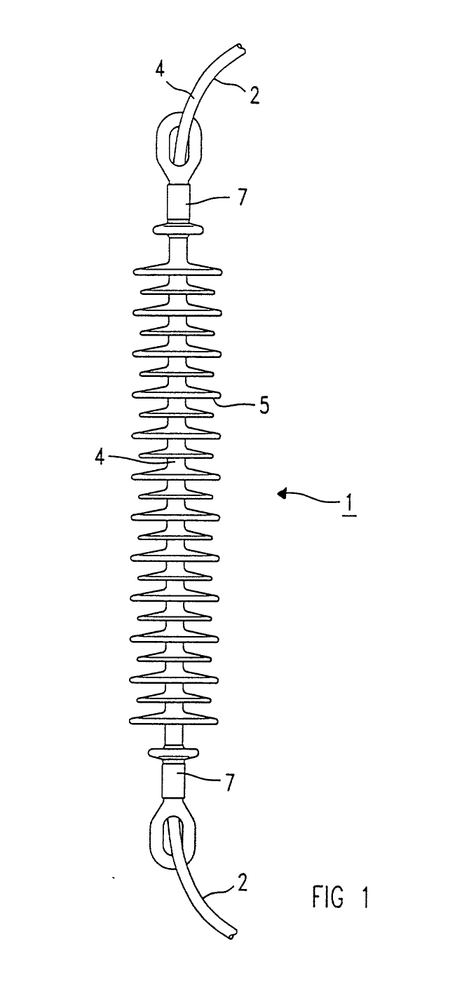

In all the figures of the drawing, sub-features and integral parts that correspond to one another bear the same reference symbol in each case. Referring now to the figures of the drawing in detail and first, particularly, to FIG. 1 thereof, there is shown an optical fiber configuration 1 with an optical fiber cable 2 which extends, for example, between a high-voltage conductor and foundations at ground potential. The optical fibers contained in the optical fiber cable 2 are, for example, coupled to a measuring device in the form of a current transformer disposed on the high-voltage conductor. Such a current transformer may be configured for example as a Faraday sensor, in which an optical fiber loop surrounds the high-voltage conductor.

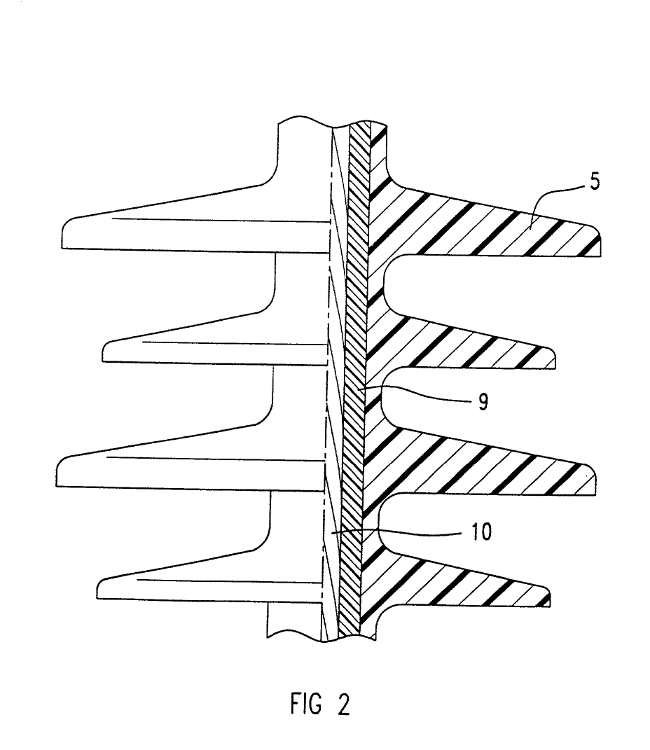

A flexible insulating sleeve 4 of the optical fiber cable 2 has, at least on one section, peripheral shields 5 made of an insulating material in the form of a silicone rubber. The shielded section in this case bridges the electric potential difference. The shields 5 are applied directly to a sheath - which cannot be seen here - made of a glass fiber reinforced plastic. Epoxy resin is used as the plastic. For fastening on the high-voltage system, connection fittings 7 are provided on both sides of the section. The connection fittings 7 have in this case been pressed directly onto a glass reinforced plastic (GRP) sheath 9, see FIG. 2.

In FIG. 2 it is shown that the shields 5 have been applied directly to the glass reinforced plastic (GRP) sheath 9. Inside the GRP sheath 9 lies a buffer tube 10, which receives one or more optical fibers 12. The buffer tube 10 in this case contains PBT, the optical fibers 12, surrounded by a gel, being embedded in the buffer tube 10.

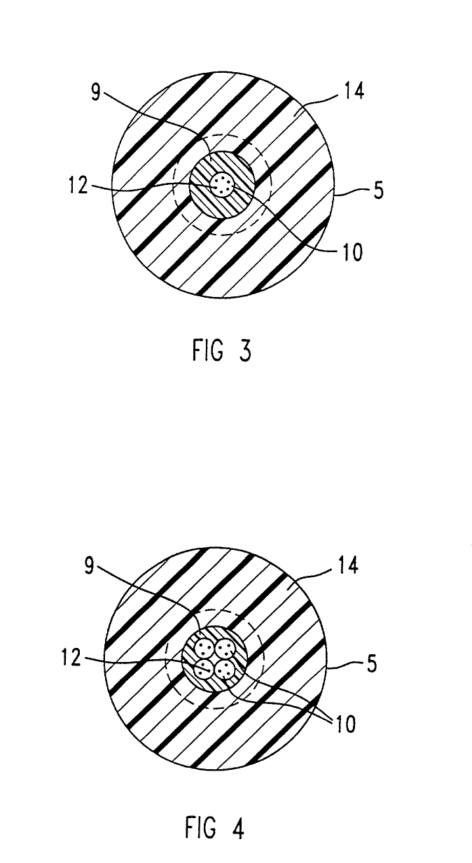

FIG. 3 shows in a cross section of the optical fiber configuration 1 a plurality of the optical fibers 12 inside the buffer tube 10. The buffer tube 10 is sheathed with the sheath 9 made of glass fiber reinforced epoxy resin. The peripheral shields 5 made of the silicone rubber used as an insulating material 14 have been applied directly to the GRP sheath 9.

A further embodiment is represented in FIG. 4. There, a plurality of the buffer tubes 10, in which a plurality of optical fibers 12 in turn run, are disposed within the GRP sheath 9. The shields 5 made of the insulating material 14 have been applied directly to the GRP sheath 9.

I claim:

1. An optical fiber configuration, comprising:
a sheath made of a glass fiber reinforced plastic;
a flexible insulating sleeve having peripheral shields disposed along at least on one section of said flexible insulating sleeve, said peripheral shields made of an insulating material and applied directly to said sheath; and
an optical fiber for transmitting information over an electrical potential difference, the optical fiber being disposed in said flexible insulating sleeve.

2. The optical fiber configuration according to claim 1, including a buffer tube disposed in said sheath for additionally sheathing said optical fiber.

3. The optical fiber configuration according to claim 2, wherein said optical fiber is one of a plurality of optical fibers grouped together in said buffer tube.

4. The optical fiber configuration according to claim 1, including a plurality of buffer tubes disposed within said sheath.

5. The optical fiber configuration according to claim 1, including a connection fitting pressed onto said sheath.
